(19) United States
(12) Patent Application Publication
(10) Pub. No.: US 2004/0051815 A1
(43) Pub. Date: Mar. 18, 2004

(54) Apparatus for providing tuner parameters in a television receiver

(76) Inventors: Feroz Kaiki Alpaiwalia, Indianapolis, IN (US); Edward Allen Hall, Fort Wayne, IN (US); Eugene Murphy O'Donnell, Fishers, IN (US); Edward Charles Maexner, Indianapolis, IN (US)

Correspondence Address: Joseph S Tripoli, Thomson Multimedia Licensing Inc, P O Box 5312, Princeton, NJ, 08543-5312, US

(21) Appl. No.: 10/297,312

(22) PCT Filed: Jun. 5, 2001
(86) PCT No.: PCT/US01/18143

(51) Int. Cl. H04N 5/50

(52) U.S. Cl. 348/731; 348/714

(57) ABSTRACT

A television receiver comprising a tuner, a microprocessor, a communications bus and a rewritable memory, e.g., an electrically erasable programmable read only memory (EEPROM). The memory is programmed to contain the tuner parameters for a tuner. The memory can be programmed to be matched with a tuner such that, on the manufacturing floor, the tuner from each manufacture is supplied with a matched memory for the television chassis that the tuner and memory are going to be placed within. The tuner parameters are recalled by the microprocessor and used to facilitate tuning of the tuner in a conventional manner.

The invention generally relates to television receivers and, more particularly, to tuners used in television receivers. The term “television receiver” herein includes any television signal receiver with or without display.

Television tuners are used in television receivers such as television sets, video cassette recorders, home entertainment systems, and the like. The tuners are implanted as either discrete tuner modules or as onboard tuner circuits integrated into a chassis (“tuner-on-board”). Both discrete tuner modules and onboard tuner circuits often include phase lock loop (PLL) circuits that facilitate reception of television signals.

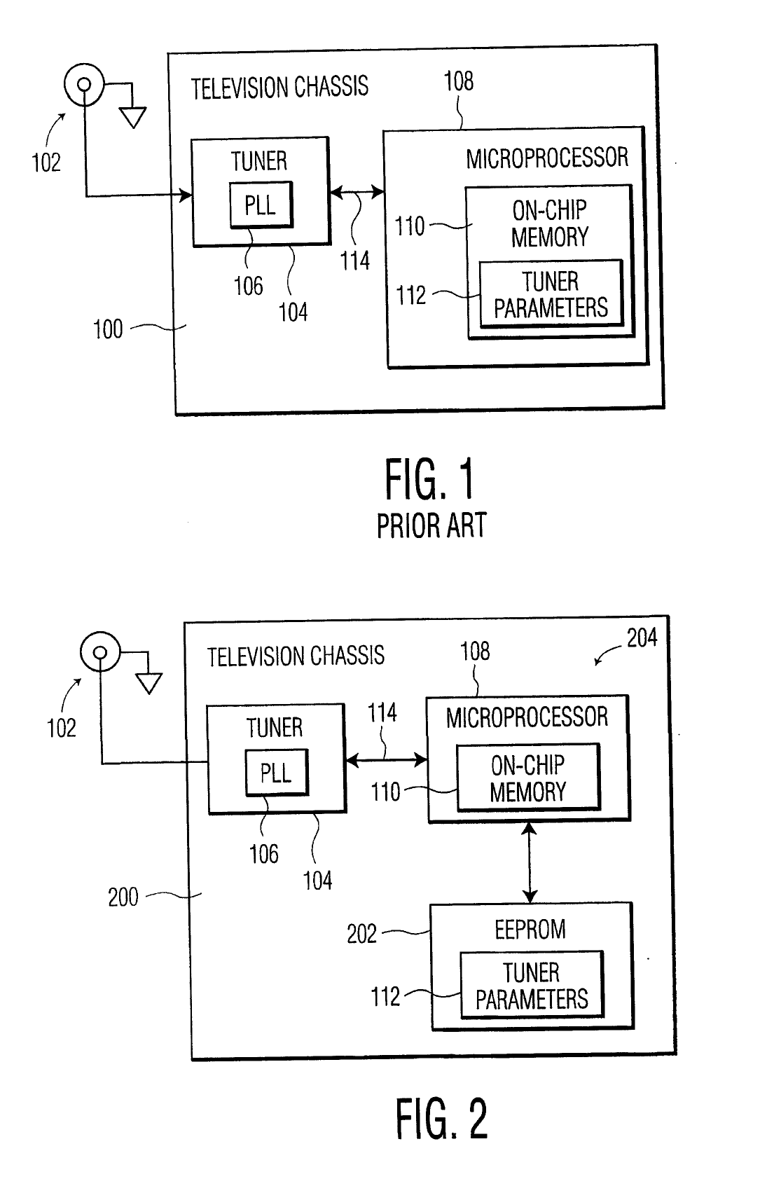

FIG. 1 depicts a portion of a prior art television chassis 100 that is conventionally found in a television receiver. The television chassis 100 comprises a tuner 104 having a phase lock loop 106 and a microprocessor 108 having an on-chip memory 110. The tuner 104 is coupled to the microprocessor 108 via a communications bus 114, e.g., an inter-integrated circuit (12C) bus. The input port 102 for the television chassis 100 is coupled to an antenna, a cable feed or the like. The tuner 104 is typically a single conversion tuner, although a double conversion tuner may be used. The selection of a channel to receive by the television receiver is performed by the microprocessor 108 instructing the tuner 104 and the phases loop 106 to tune to a particular channel for reception. The tuner parameters 112 that are used to control the phase lock loop 106 are generally stored within an on-chip memory 110. That is, a tuner's parameters are “hard coded” in the memory that is embedded in the microprocessor. As such, if the tuner 104 is a module that is manufactured separately from the television chassis, the tuner functionality must be well matched from tuner-to-tuner so that the same tuner parameters can be stored in the on-chip memory 110 in a hard coded manner for all tuner modules.

Electronic tuner control is a process whereby control data (also referred to herein as the tuner parameters) for a particular tuner are stored in nonvolatile memory (on-chip memory 110) within the microprocessor 108. When a user selects a desired channel, the microprocessor 108 within the television receiver chassis 100 identifies (looks up) the control data stored in the nonvolatile memory 110 for the desired channel. The control data is then communicated to the television tuner 104.

Tuner manufacturers use a variety of phase-locked loop (PLL) integrated circuits (ICs) in their tuner designs. The PLL IC is used to adjust the operating frequency of the tuner and thereby cause the television to receive the desired television channel. Since the frequency range to be covered spans over 700 MHZ, the PLL achieves broad band tuning by dividing this frequency range into convenient sections—typically three or four. These sections are known as bands, e.g., VHF low, VHF high and VHF.

The division of the covered frequency range is arbitrary and varies between tuner designs. This frequency range information for each band in the tuner forms part of the control data that is stored in nonvolatile memory 110.

The stored control data also contains instructions that direct the PLL to synthesize the desired frequency and the mode of operation of that particular PLL IC. The control data controls the PLL for the selected channel, and controls various switch circuits within the tuner, i.e., VHF low, VHF high and UHF band selections.

While electronic control eases the design requirements, it narrows compatibility among television receiver components. The microprocessor 108 must contain specific routines for selecting and communicating the control data from the on-chip memory 110 to the tuner 104. The tuner 104 must be adapted to accept the data and compensate for mismatches. As Such, replacement of malfunctioning television tuners in the field requires finding a new television tuner that is adapted to be controlled by a particular microprocessor and a particular set of tuner parameters.

When discrete tuner modules are utilized within the television chassis and those modules are manufactured by various tuner manufacturers, the tuner parameters that are to be stored in the on-chip memory varies from tuner-to-tuner. As such, the on-chip memory must be specially programmed with different data for each and every tuner type that is supplied from a different manufacturer for the television chassis. Since on-chip memory storage is of a limited size, it is not practical to store tuner parameters for every type of tuner that can be used with a television chassis. As such, a single set of parameters is stored for a particular tuner In the on-chip memory 110. Thus, a faulty tuner can not be replaced without replacing the microprocessor 108.

Therefore, the need exists in the art for a method and apparatus for flexibly storing tuner parameters within a television chassis

The present invention is a television chassis comprising a tuner, a microprocessor, a communications bus and a replaceable nonvolatile memory, e.g., an electrically erasable programmable read only memory (EEPROM). The replaceable nonvolatile memory is programmed to contain the tuner control parameters for a tuner at the time of chassis manufacture, allowing for quick adjustment to a change in the tuner type. The memory can be programmed for a tuner such that on the manufacturing floor the tuner from each manufacturer is supplied with matching control parameters for the television chassis that the tuner is going to be placed within. Once the television is assembled, the tuner parameters are recalled by the microprocessor and used to facilitate electronic control of the tuner and phase lock loop in a conventional manner. While using a separate programmable memory to store the tuner parameters, the invention avoids the problem of having to program an on-chip memory within the microprocessor for each and every type of tuner module that is used in the television chassis.

So that the manner in which the above recited features of the present invention are attained and can be understood in detail, a more particular description of the invention, briefly summarized above, may be had by reference to the embodiments thereof which are Illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a portion of a block diagram of a prior art television chassis; and

FIG. 2 depicts a portion of a block diagram of a television chassis in accordance with the present invention.

To facilitate understanding, identical reference numerals have been used, where possible, to designate identical elements that are common to the figures.

After considering the following description, those skilled in the art will clearly realize that the teachings of this invention can be readily utilized in a television receiver. This disclosure involves a television tuner in which a rewritable memory is used in conjunction with a microprocessor to facilitate tuning of the tuner. The rewritable memory stores the tuner control parameters for a phase lock loop within the tuner.

FIG. 2 depicts a block diagram of one embodiment of a television chassis 200 in accordance with the invention. The television chassis 200 comprises an input port 102 for receiving RF signals, e.g., television signals, a tuner 104 having a phase lock loop 106, a microprocessor 108 having on-chip memory 110, and a rewritable memory 202 for storing tuner parameters 112. The tuner 104 is coupled through a communications bus 114 to a tuner control system 204 comprising the microprocessor 108 and memory 202. The tuner receives television signals through the port 102 that is typically connected to a cable, a digital video disk, a video cassette recorder, or any other source of television signals.

The tuner module 104 selects an RF signal corresponding to desired television channels selected from a plurality of channel locations in a frequency band provided by the RF source. The RF signals associated with television channels may be analog and/or digital television signals. The analog television signal may comprise a conventional National Television Standard Committee (NTSC) modulated signal within the United States. The digital television signal may comprise a vestigial side band (VSB) modulated signal in compliance with the Advanced Television Systems Committee (ATSO) standard A/53, for example, a high definition television (HDTV) signal. The system described herein could also be configured to function with other formats, such as European, by appropriate changes in the television control system 204.

The tuner module 104 select the desired television channel to be displayed on a display pursuant to a tuning command generated by the microprocessor 108. The microprocessor 108 is coupled to the tuner module 104 via the communications bus 114. In the embodiment, the communications bus 114 may be an inter-integrated circuit (12C) bus, a three wire bus or any type of communications bus. In addition to a tuning command generated by the microprocessor 108, the microprocessor recalls the tuner parameters 112 from the memory 202 for use with tuner module 104. These tuner parameters 112 are passed through the communications bus 114 to the phase lock loop 106 within the tuner module 104.

Memory 202 is rewritable type memory of a nonvolatile nature that may include, but is not limited to, read only memory (ROM) or programmable read only memory (PROM), the later of which may be subdivided into an electrically programmable ROM (EPROM), electrically erasable programmable ROM (EEPROM) and one time PROM (OTPROM). The memory 202 is simultaneously programmed with a plurality of other memories using “bulk” programming techniques prior to installing the memory 202 in the chassis 200. Electronically programmable memory may be programmed with the correct tuner control information during chassis manufacture. The control data 112 comprises digital information necessary to for the tuner PLL 106 to synthesize the correct frequency for receiving selected television signals.

In this manner, the tuner module 104 is electronically tuned to provide the correct frequency and best performance for the desired television channel. The tuner module 104 contains all necessary data for tuner control after that tuner parameters are passed from the microprocessor to the phase lock loop 106 to facilitate tuner control. As such, the tuner module 104 is a discrete component within the television chassis 200 which allows, for example, the replacement of the tuner module 104 in the field without changing the television control system 204, specifically, the microprocessor 102. When using the invention, the tuner module 104 can be changed with a matched memory 202 to facilitate changing the tuner parameters 112 to match the new tuner 104.

Although various embodiments that incorporate the teachings of the present invention have been shown and described in detail herein, those skilled in the art can readily devise many other varied embodiments that still incorporate these teachings. For example, the disclosed invention can be used for FM broadcast radio receivers.

1. A television receiver comprising:
a tuner (104);
a microprocessor (108);
a rewritable memory (202), located external to said microprocessor (108) and coupled to said microprocessor (108), for storing tuner parameters (112); and
a communications bus (114) connecting said microprocessor (108) to said tuner (104), where during television channel selection at least one tuner parameter is transferred from said rewritable memory (202) to said tuner (104).

2. The television receiver of claim 1 wherein said rewritable memory (202) includes a programmable read only memory.

3. The television receiver of claim 2 wherein said programmable read only memory (202) includes an electrically erasable programmable read only memory.

4. The television receiver of claim 1 wherein said rewritable memory (202) is removable.

5. The television receiver of claim 1 wherein said tuner parameters (112) are matched to said tuner(104).

6. The television receiver of claim 1 wherein said tuner (104) includes a phase lock loop (106) and said parameters (112) includes phase lock loop control data.

7. The television receiver of claim 6 wherein said control data includes signal band switching information.

8. A television receiver comprising:
tuning means (104);
control means (108);
memory means (202), located external to said control means (108) and coupled to said control means (108), where during television channel selection at least one tuning parameter is transferred from said memory means (202) to said tuning means (104).

9. The television receiver of claim 8 wherein said memory means (202) includes a programmable read only memory.

10. The television receiver of claim 3 wherein said programmable read only memory (202) includes an electronically erasable programmable read only memory.

11. The television receiver of claim 8 wherein said memory means (202) is removable.

12. The television receiver of claim 8 wherein said tuning parameters (112) are matched to said tuning means (104).

13. The television receiver of claim 8 wherein said tuning means (104) includes a phase lock loop (106) and said tuning parameters (112) includes phase lock loop control data.

14. The television receiver of claim 13 wherein said control data includes signal band switching information.
